(19) United States
(12) Patent Application Publication
(10) Pub. No.: US 2021/0390464 A1
(43) Pub. Date: Dec. 16, 2021

(54) LEARNING INTERPRETABLE RELATIONSHIPS BETWEEN ENTITIES, RELATIONS, AND CONCEPTS VIA BAYESIAN STRUCTURE LEARNING ON OPEN DOMAIN FACTS

(71) Applicants: Baidu USA, LLC, Sunnyvale, CA (US); Baidu.com Times Technology (Beijing) Co., Ltd., Beijing (CN)

(72) Inventors: Jingyuan ZHANG, San Jose, CA (US); Mingming SUN, Beijing (CN); Ping LI, Bellevue, WA (US)

(73) Assignees: Baidu USA LLC, Sunnyvale, CA (US); Baidu.com Times Technology (Beijing) Co., Ltd., Beijing, CA (CN)

(21) Appl. No.: 17/040,292

(22) PCT Filed: Jun. 16, 2020
(86) PCT No.: PCT/CN2020/096396

§ 371 Date: Sep. 22, 2020

(51) Int. Cl. G06N 20/10; G06N 7/00; G06N 5/04

(52) U.S. Cl. CPC G06N 20/10; G06N 5/04; G06N 7/005

(57) ABSTRACT

Concept graphs are created as universal taxonomies for text understanding in the open domain knowledge. The nodes in concept graphs include both entities and concepts. The edges are from entities to concepts, showing that an entity is an instance of a concept. Presented herein are embodiments that handle the task of learning interpretable relationships from open domain facts to enrich and refine concept graphs. In one or more embodiments, the Bayesian network structures are learned from open domain facts as the interpretable relationships between relations of facts and concepts of entities. Extensive experiments were conducted on English and Chinese datasets. Compared to the state-of-the-art methods, the learned network structures improve the identification of concepts for entities based on the relations of entities on both English and Chinese datasets.

### TECHNICAL FIELD

The present disclosure relates generally to systems and methods for computer learning that can provide improved computer performance, features, and uses. More particularly, the present disclosure relates to systems and methods for learning interpretable relationships between entities, relations, and concepts.

### BACKGROUND

Concept graphs are typically created as universal taxonomies for text understanding and reasoning in the open domain knowledge. The nodes in concept graphs may include both entities and concepts. The edges are typically from entities to concepts, showing that an entity is an instance of a concept. For example, the entity, “Canada,” may be linked via an edge to the concept of “Country” to indicate that “Canada” is an instance of a “Country.”

The task of extracting and building concept graphs from user-generated texts has attracted a lot of research attention for at least a couple of decades. Most of these methods rely on high quality syntactic patterns to determine whether an entity belongs to a concept. For example, given the pattern “X is a Y” or “Y, including X” appearing in sentences, one may infer that the entity X is an instance of the concept Y. However, as illustrated by the examples, these pattern-based methods require that an entity and concept pair co-occur in sentences. However, due to the different expressions of a certain concept, an entity and a concept may rarely appear in sentences together. A data analysis of millions of sentences extracted from Wikipedia was conducted, and it was discovered that only 10.61% of entity-concept pairs co-occur in sentences out of more than six million of pairs from a concept graph. Baidu Baike (baike.baidu.com) was and its corresponding concept graph was also analyzed. A similar phenomenon was observed that only 8.56% entity-concept pairs co-occur in sentences. Table 1 shows the statistics for the two datasets. With such limitations, the existing approaches have difficulties in helping build a complete concept graph from open domain texts.

TABLE 1
Entity-concept pairs that co-occur in sentences from Dataset
1 (English) and Dataset 2 (Baidu Baike (Chinese)).

| Dataset | # Pairs | # Sentences | # Co-occurrence | Percentage |
|---|---|---|---|---|
| Dataset 1 | 6,347,294 | 7,871,825 | 673,542 | 10.61% |
| Dataset 2 | 3,229,301 | 9,523,183 | 276,485 | 8.56% |

Given that co-occurrence is relatively low in open domain information, such as user-generated data, finding entity-concept relations for concepts graphs can be extremely challenging.

Accordingly, what is needed are new systems and methods to generate concept graphs and/or to enrich and refine concept graphs.

### SUMMARY

Embodiments of the present disclosure provide a computer-implemented method, a non-transitory computer-readable medium or media, and a system.

According to a first aspect, some embodiments of the present disclosure provide a computer-implemented method, the method includes: obtaining a set of entities that are identified in a concept graph as being associated with a concept; searching an information repository comprising facts from open domain information to obtain a set of facts that contain an entity from the set of entities as either a subject or an object of a fact, in which each fact comprises a subject entity, an object entity, and a relation that represents a predicate or relationship between the subject entity and the object entity; using at least some of the set of facts to generate positive data observations for the concept that relate at least some of the entities in the set of entities to one or more relations from the set of facts; using a Bayesian network structure learning methodology and at least some of the positive data observations to learn a Bayesian network for the concept to discover a network structure between entities, relations, and the concept; and outputting the learned Bayesian network for the concept to use for predicting whether a new entity is an instance of the concept.

According to a second aspect, some embodiments of the present disclosure provide a non-transitory computer-readable medium or media comprising one or more sequences of instructions which, when executed by at least one processor, causes steps to be performed, the steps include: obtaining a set of entities that are identified in a concept graph as being associated with a concept; searching an information repository comprising facts from open domain information to obtain a set of facts that contain an entity from the set of entities as either a subject or an object of a fact, in which each fact comprises a subject entity, an object entity, and a relation that represents a predicate or relationship between the subject entity and the object entity; using at least some of the set of facts to generate positive data observations for the concept that relate at least some of the entities in the set of entities to one or more relations from the set of facts; using a Bayesian network structure learning methodology and at least some of the positive data observations to learn a Bayesian network for the concept to discover a network structure between entities, relations, and the concept; and outputting the learned Bayesian network for the concept to use for predicting whether a new entity is an instance of the concept.

According to a third aspect, some embodiments of the present disclosure provide a system, the system includes: one or more processors; and a non-transitory computer-readable medium or media comprising one or more sets of instructions which, when executed by at least one of the one or more processors, causes steps to be performed comprising: obtaining a set of entities that are identified in a concept graph as being associated with a concept; searching an information repository comprising open domain facts to obtain a set of facts that contain an entity from the set of entities as either a subject or an object of a fact, in which each fact comprises a subject entity, an object entity, and a relation that represents a predicate or relationship between the subject entity and the object entity; using at least some of the set of facts to generate positive data observations for the concept that relate at least some of the entities in the set of entities to one or more relations from the set of facts; using a Bayesian network structure learning methodology and at least some of the positive data observations to learn a Bayesian network for the concept to discover a network structure between entities, relations, and the concept; and outputting the learned Bayesian network for the concept to use for predicting whether a new entity is an instance of the concept.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it shall be understood that it is not intended to limit the scope of the disclosure to these particular embodiments. Items in the figures may not be to scale.

FIG. 1 graphically depicts relationships of entities, relations, and concepts, according to embodiments of the present disclosure.

FIG. 2 graphically depicts workflows of learning interpretable relationships from open domain facts for concept discovery, according to embodiments of the present disclosure.

FIG. 3 depicts workflows of learning interpretable relationships from open domain facts for concept discovery, according to embodiments of the present disclosure.

FIG. 4 depicts a method for obtaining a set of relevant facts, according to embodiments of the present disclosure.

FIG. 5 depicts a method for relation selection, according to embodiments of the present disclosure.

FIG. 6 depict a method for generating data observations, according to embodiments of the present disclosure.

FIG. 7 depicts a method for generating negative data observations, according to embodiments of the present disclosure.

FIG. 8 depicts a method for learning a network structured, according to embodiments of the present disclosure.

FIG. 9 depicts a method for using a learned network for predicting whether an entity is an instance of the concept, according to embodiments of the present disclosure.

FIG. 10 contains Table 3, which depicts performance on co-occurred data, according to embodiments of the present disclosure.

FIG. 11 contains Table 4, which depicts performance on non-co-occurred data, according to embodiments of the present disclosure.

FIG. 12 contains Table 5, which depicts performance of relation selections on the entire data, according to embodiments of the present disclosure. The results are reported as “value+(rank)”.

FIG. 13 depicts results of a tested BNSL(s) embodiment with different numbers of relations on an English dataset (graph 1305) and on a Chinese dataset (graph 1310), according to embodiments of the present disclosure.

FIG. 14 depicts F1-score improvement on RNN(sen) on an English dataset (graph 1440) and on a Chinese dataset (graph 1450), according to embodiments of the present disclosure.

FIG. 15 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” and “comprising” shall be understood to be open terms and any lists the follow are examples and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded.

In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); (5) an acceptable outcome has been reached; and/or (6) processing of input data has completed.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

### 1. General Introduction

As discussed above, concept graphs are created as universal taxonomies for text understanding and reasoning in the open domain knowledge. However, prior approaches that rely upon entity-concept pairs co-occur in sentences have difficulties in helping build a complete concept graph from open domain texts because of the small percentage of co-occurrence in open domain texts.

Nowadays, the task of open domain information extraction (OIE) has become more and more important. OIE aims to generate entity and relation level intermediate structures to express facts from open domain sentences. These open domain facts usually express natural languages as triples in the form of (subject, predicate, object). It shall be noted that the term “facts” is being use to represent statements with a subject, object, and predicate; while it may be assumed that the “facts” are true, their veracity is not an issue of the current disclosure. For example, given the sentence “Anderson, who hosted Whose Line, is a winner of a British Comedy Award in 1991.”, two facts will be extracted. They are (“Anderson”, “host”, “Whose Line”) and (“Anderson”, “winner of a British Comedy Award”, “1991”). The subject and object in a fact may both be considered entities. The open domain facts contain rich information about entities by representing the subject or object entities via different types of relations (i.e., groups of predicates). Thus, it would be helpful for concept graph completion if one could take advantage of the relations in open domain facts. By way of illustration, again take the above two facts of “Anderson” as an instance. If one has explored the connections between relations of facts and concepts, and learned that “host” and “winner of a British Comedy Award” are associated with an “English presenter” subject with a higher probability than a “Japanese presenter” subject, one may infer that “Anderson” belongs to the “English presenter” concept regardless of whether these two co-appear in a sentence or not.

In a real-world open domain corpus, however, the connections between relations and concepts are not available. In this patent document, the task of learning interpretable relationships between entities, relations, and concepts from open domain facts is presented to help enrich and refine concept graphs.

Learning Bayesian networks (BNs) from data has been studied extensively in the last few decades. The BNs formally encode probabilistic connections in a certain domain, yielding a human-oriented qualitative structure that facilitates communication between a user and a system incorporating the probabilistic model. In one or more embodiments, a Bayesian network structure learning (BNSL) may be used to discover meaningful relationships between entities, relations, and concepts from open domain facts. In one or more embodiments, the learned network encodes the dependencies from the relations of entities in facts to the concepts of entities, leading to the identification of more entity-concept pairs from open domain facts for the completion of concept graphs.

As a preliminary matter, embodiments herein frame a problem to help address the deficiencies of prior approach. In one or more embodiments, the task may be uniquely framed as a task of learning interpretable relationships between entities, relations, and concepts from open domain facts, which is important for enriching and refining concept graphs. In one or more embodiments, to solve the framed problem, BNSL models are built to discover meaningful network structures that express the connections from relations of entities in open domain facts to concepts of entities in concept graphs.

Experimental results on both English and Chinese datasets reveal that the learned interpretable relationships help identify concepts for entities based on the relations of entities, resulting in a more complete concept graph.

### 2. Some Related Work

2.1. Concept Graph Construction.

Concept graph construction has been extensively studied in the literature. Notable works toward creating open domain concept graphs from scratch include YAGO (Fabian M. Suchanek, Gjergji Kasneci, and Gerhard Weikum. 2007. Yago: a core of semantic knowledge. In Proceedings of the 16th International Conference on World Wide Web (WWW), pages 697-706, Banff, Canada) and Probase (Wentao Wu, Hongsong Li, HaixunWang, and Kenny Q Zhu. 2012. Probase: A probabilistic taxonomy for text understanding. In Proceedings of the ACM SIGMOD International Conference on Management of Data (SIGMOD), pages 481-492, Scottsdale, Ariz.). In addition, a wide variety of methods have been developed to detect the hypernymy between entities and concepts for a more complete concept graph. Distributional representations of entities and concepts have been learned for good hypernymy detection results.

In contrast to distributional methods, path-based algorithms have been proposed to take advantage of the lexico-syntactic paths connecting the joint occurrences of an entity and a concept in a corpus. Most of these methods require the co-occurrence of entity and concept pairs in sentences for the graph completion task. However, due to the different expressions of a certain concept, an entity and a concept may rarely appear in one sentence together. With such limitations, the existing methods in the literature cannot deal with those non co-occurring entity concept pairs, leading to an incomplete concept graph.

2.2. Open Domain Information Extraction

Open domain information extraction (OIE) has attracted a lot of attention in recent years. It extracts facts from open domain documents and expresses facts as triples of (subject, predicate, object). Recently, a neural-based OIE system Logician (see Mingming Sun, Xu Li, and Ping Li. 2018a. Logician and Orator: Learning from the duality between language and knowledge in open domain. In Proceedings of the 2018 Conference on Empirical Methods in Natural Language Processing (EMNLP), pages 2119-2130, Brussels, Belgium; Mingming Sun, Xu Li, XinWang, Miao Fan, Yue Feng, and Ping Li. 2018b. Logician: a unified end-toend neural approach for open-domain information extraction. In Proceedings of the Eleventh ACM International Conference on Web Search and Data Mining (WSDM), pages 556-564, Marina Del Rey, Calif.; Guiliang Liu, Xu Li, Mingming Sun, and Ping Li. 2020a. An advantage actor-critic algorithm with confidence exploration for open information extraction. In Proceedings of the 2020 SIAM International Conference on Data Mining (SDM), pages 217-225; and Guiliang Liu, Xu Li, Jiakang Wang, Mingming Sun, and Ping Li. 2020b. Large scale semantic indexing with deep level-wise extreme multi-label learning. In Proceedings of the World Wide Web Conference (WWW), pages 2585-2591, Taipei) has been proposed. It introduces a unified knowledge expression format SAOKE (symbol aided open knowledge expression) and expresses the most majority information in natural language sentences into four types of facts (i.e., relation, attribute, description, and concept). Logician is trained on a human-labeled SAOKE dataset using a neural sequence-to-sequence model. It achieves a much better performance than traditional OIE systems in Chinese language and provides a set of open domain facts with much higher quality to support upper-level algorithms. Since the subject and object in a fact are both entities, the open domain facts contain rich information about entities by representing the subjects or objects via different types of relations (i.e., groups of predicates). It can help the task of concept graph completion by making full use of the relations in open domain facts. In this patent document, the high-quality facts of Logician are leveraged as one dataset in the experiment.

2.3. Bayesian Network Structure Learning.

Learning a Bayesian network structure from real-world data is a well-motivated but computationally hard task. A Bayesian network specifies a joint probability distribution of a set of random variables in a structured fashion. An important component in this model is the network structure, a directed acyclic graph on the variables, encoding a set of conditional independence assertions. Several exact and approximate algorithms have been developed to learn optimal Bayesian networks (see, e.g., C. K. Chow and C. N. Liu. 1968. Approximating discrete probability distributions with dependence trees. IEEE Trans. Inf. Theory, 14(3):462-467; Mikko Koivisto and Kismat Sood. 2004. Exact Bayesian structure discovery in Bayesian networks. J. Mach. Learn. Res., 5:549-573; Ajit P Singh and Andrew W Moore. 2005. Finding optimal Bayesian networks by dynamic programming; Tomi Silander and Petri Myllymaki. 2006. A simple approach for finding the globally optimal Bayesian network structure. In Proceedings of the 22nd Conference in Uncertainty in Artificial Intelligence (IJCAI), Cambridge, Mass.; Changhe Yuan, Brandon M. Malone, and XiaoJian Wu. 2011. Learning optimal bayesian networks using A*search. In Proceedings of the 22nd International Joint Conference on Artificial Intelligence (IJCAI), pages 2186-2191, Barcelona, Spain; and Changhe Yuan and Brandon M. Malone. 2013. Learning optimal bayesian networks: A shortest path perspective. J. Artif. Intell. Res., 48:23-65.) Some exact algorithms are based on dynamic programming to find the best Bayesian network. In 2011, an A* search algorithm was introduced to formulate the learning process as a shortest path finding problem. However, these exact algorithms can be inefficient due to the full evaluation of an exponential solution space. While any of the exact or approximate methods may be employed, in one or more embodiments, the Chow-Liu tree building algorithm (C. K. Chow and C. N. Liu. 1968. Approximating discrete probability distributions with dependence trees. IEEE Trans. Inf. Theory, 14(3):462-467) is used to approximate the underlying relationships between entities, relations, and concepts as a dependency tree. This method is very efficient when there are large numbers of variables.

### 3. Finding Interpretable Relationships

In one or more embodiments, the relationships between entities, relations, and concepts may be formulated as follows:

Entities are associated with a set of relations that represent the behaviors and attributes of entities; and

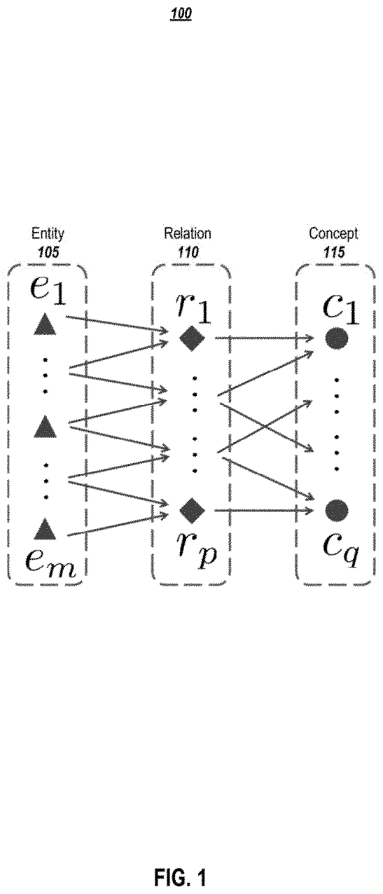

A concept may be defined by a set of relations. The instances of a concept are those entities that associate with the corresponding set of relations. In concept graphs, a concept is associated with a set of entities, which share some common behaviors or attributes. However, one essence of a concept is a set of relations, and entities which associate with these relations automatically become the instance of the concept. Embodiments of a formulation of the relationships between entities 105, relations 110, and concepts 115 is illustrated by FIG. 1.

In the closed domain, a knowledge base has a predefined ontology and the relationships in FIG. 1 are already known. For example, DBPedia builds a knowledge graph from Wikipedia to encode the relationships between entities and relations in the forms of facts. The relationships between relations and concepts are represented in the ontology structure of DBPedia, where each concept is associated with a group of relations.

However, in the open domain, a predefined ontology does not exist, and hence the components in FIG. 1 may not be associated with each other. For instance, given an open domain concept graph, one can discover the relationships between entities and concepts. Given the open domain corpus/facts, one can find the relationships between entities and relations. But the relationships between open domain concepts and relations are not available. In this patent document, one or more embodiments find connections between open domain relations and concepts, so that one can provide interpretations to the question “why the entity is associated with those concepts in open domain”.

3.1. Problem Formulation

Suppose there are a set of entities E={e₁, . . . , eₘ}, a set of relations R={r₁, . . . , rₚ}, a set of concepts C={c₁, . . . , c_{q}}, and a set of observed triplets O={(e,r,c)}. Here E and C are from a concept graph G. R is from a set of facts F={f₁, . . . , fₙ} extracted from a text corpus D. A triplet (e,r,c) is observed means that the entity e with relation r and concept of c is found in above data sources. Given a set of observations O with N samples, a Bayesian network can be learned by maximizing the joint probability p(O):

$$\begin{matrix}p ( O ) = {\prod }_{( e , r , c ) ∈ O} p ( ( e , r , c ) ) \\ = {\prod }_{( e , r , c ) ∈ O} p ( c \vert ( e , r ) ) \cdot p ( r \vert e ) \cdot p ( e ) \\ = {\prod }_{( e , r , c ) ∈ O} p ( c \vert r ) \cdot p ( r \vert e ) \cdot p ( e )\end{matrix}$$

where p(c|(e,r))=p(c|r) is due to Bayesian network assumption (see FIG. 1). By learning with the observed triplets with the above model, the missing triplets may be inferred, especially give interpretable relationships between entities and concepts.

Since p(r|e) can be approximated by the information from an OIE corpus, a core of the above problem becomes to learn the part of the network of p(c|e). The difficulty of learning p(c|e) is the unknown structure of the Bayesian network. Due to sparsity of real-world knowledge base, the target network would be sparse. But the sparse structure should be known beforehand for probability learning.

In this patent document, embodiments of the Bayesian Network Structure Learning (BNSL) technique are employed to explore the connections between relations and concepts. Due to the large number of variables (i.e., entities, relations, and concepts) in open domain facts and concept graphs, in one or more embodiments, an approximate algorithm is developed to learn the network structure.

3.2. The Proposed Approximate Algorithm

Due to the sparsity of the relationships between relations and concepts, we decompose the problem into several sub-problems, with each sub-problem containing one concept variable. Then for each concept variable, possible related relations are identified and a BNSL method is applied to discover the network structure between them. Given a learned network, the learned network may be used for concept discovery.

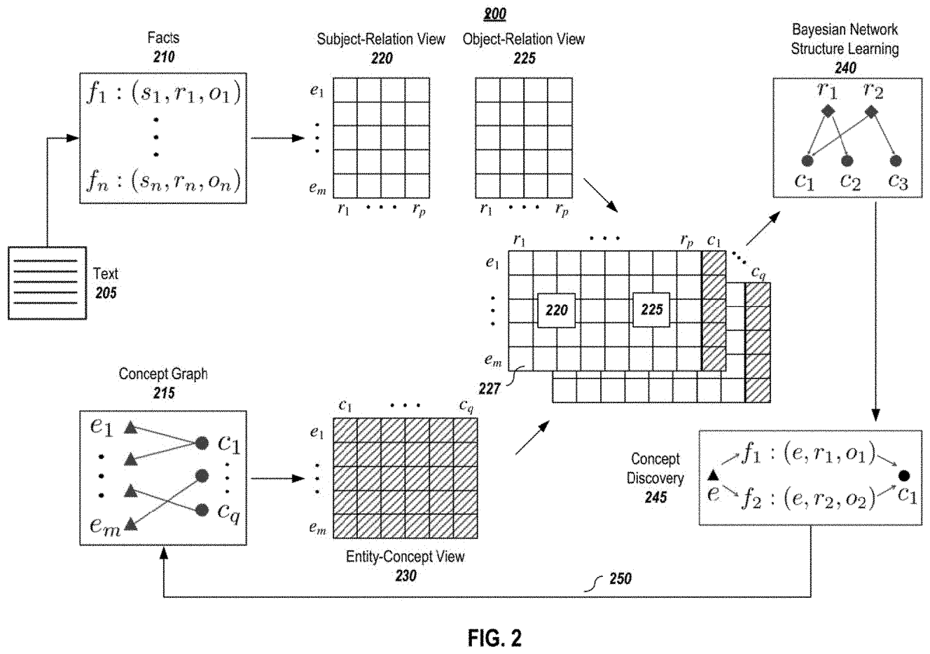

FIG. 2 graphically depicts workflows of learning interpretable relationships from open domain facts for concept discovery, according to embodiments of the present disclosure. fᵢ=(sᵢ, rᵢ, oᵢ) represents a fact, where sᵢ and oᵢ are both entities, and rᵢ is a relation, and eᵢ is used to denote an entity and cᵢ to represent a concept.

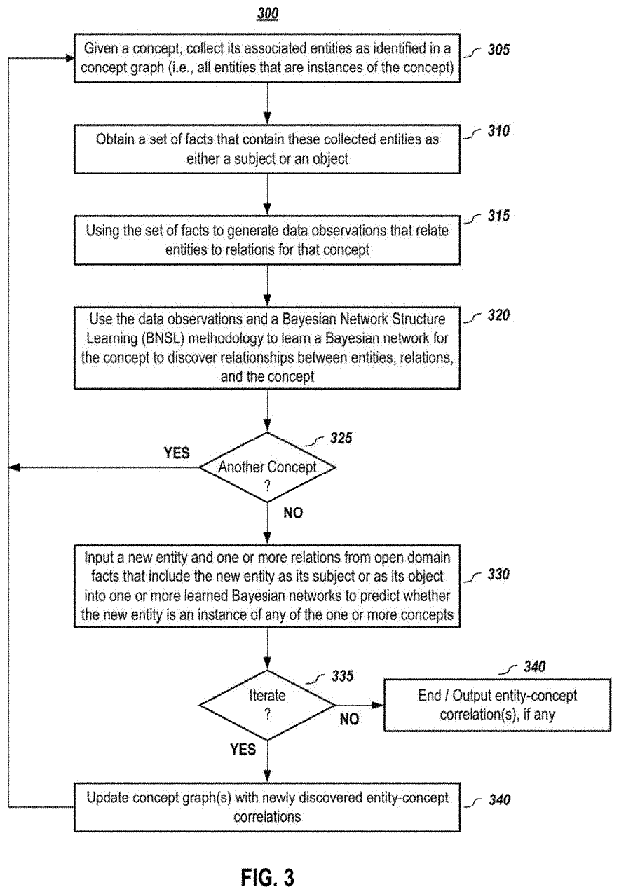

FIG. 3 depicts workflows of learning interpretable relationships from open domain facts for concept discovery, according to embodiments of the present disclosure. In one or more embodiments, given a concept, its associated entities may be collected (305) as identified in a concept graph (e.g., concept graph 215 in FIG. 2). It shall be noted that workflow embodiments may be performed for a number of concepts, in which case the entities that are instance of each concept of a set of concepts (e.g., c₁−c_{q}) may be collected, which results are graphically depicted in the entity-concept matrix 230. While not graphically depicted, the matrix includes an indication whether the entity is an instance of a concept. Note, also, that for ease of explanation some of the steps of FIG. 3 are explained in terms of a single concept.

In one or more embodiments, a set of facts 210 that contain these entities associated with the concept in the concept graph are obtained (310). As illustrated in FIG. 2, the facts 210 may be obtained by searching an information repository of facts, which may be obtained from open domain or unstructured text 205. In one or more embodiments, a fact that includes the entity as either a subject or an object may be selected for inclusion in the set of facts 210. As illustrated in FIG. 2, the facts may be split into a set of subject-view facts 220 and a set of object-view facts 225, wherein the set of subject-view facts comprise facts from the set of facts in which an entity from the set of entities for the concept is the subject entity and wherein the set of object-view facts comprise facts from the set of facts in which an entity from the set of entities is the object entity.

In one or more embodiments, the set of facts (which may be a set of subject-view facts, a set of object-view facts, or a combination thereof) is used (315) to generate data observations that relate entities to relations for that concept. For example, in one or more embodiments, for a set of facts, the number of co-occurrences in that set of facts, or a subset thereof, of an entity and a relation may be used for data observations.

In one or more embodiments, the data observations 227 (which includes 220 and 225) for a concept (e.g., concept c₁) may be input (320) into a Bayesian Network Structure Learning (BNSL) methodology to learn a Bayesian network structure for the concept to discover relationships between entities, relations, and the concepts. In one or more embodiments, the data observations 227 may include negative data observations, which may be generated using entities that are not an instance of the concept (and thus were not included in the set of entities identified at step 305).

In one or more embodiments, the result of this process is a learned Bayesian network for the concept. Thus, in one or more embodiments, the process may be repeated (325) for one or more additional concepts (e.g., concepts c₂−c_{q}).

Alternatively, or additionally, a learned Bayesian network for a concept may be used for predicting whether a previously unseen entity (e.g., a new entity) is an instance of the concept by inputting (330) the new entity and one or more relations from open domain facts that include the new entity as its subject or as its object into the learned Bayesian networks to predict whether the new entity is an instance of the concept. This process is graphically depicted at box 245 in FIG. 2. It shall be noted that the prediction process for this new entity may be repeated for other concepts using their respective learned Bayesian networks.

It shall be noted that the new discoveries made by embodiments herein may be used to further improve the entities, relations, and concepts discovery. For example, in one or more embodiments, given one or more new entities that have been predicted as instances of the concept, the concept graph may be updated (250/340) with the one or more new entities, and the process may be repeated by returning to step 305 to obtain an updated learned Bayesian network for the concept.

In any event, in one or more embodiments, prediction may be used to output (340) any entity-concept correlations.

Additional and alternative embodiments, including Methodology 1 (below), are described below and in the following sub-sections.

Methodology 1: Embodiment for BSNL for concept discovery

| | Input: Texts D and a concept graph G. | |
|---|---|---|
| | Output: Valid entity-concept pairs. | |
| | /* OIE step: | */ |
| 1 | Extract open domain facts F from D; | |
| | /* Concept discovery step: | */ |
| 2 | for each concept c ∈ C do | |
| 3 | \| Get entities E_{c} of this concept; | |
| 4 | \| Select facts F_{c} including E_{c}; | |
| | \| /* Subject view step: | */ |
| 5 | \| Split F_{c} into subject-view facts F_{c,s}; | |
| 6 | \| Select top K relations R_{c,s} from F_{c,s}; | |
| 7 | \| Get entity-relation data X_{c,s}; | |
| | \| /* Object view step: | */ |
| 8 | \| Repeat step 5 to get object-view F_{c,o}; | |
| 9 | \| Repeat step 6 to get R_{c,o} from F_{c,o}; | |
| 10 | \| Repeat step 7 to get X_{c,o}; | |
| | \| /* BNSL training step: | */ |
| 11 | \| Feed X_{c,s} and X_{c,o} into BNSL; | |
| 12 | \| Get a network structure S_{c} for c; | |
| 13 | end for | |
| | /* BNSL prediction step: | */ |
| 14 | Predict on new entities; | |
| 15 | Return valid entity-concept pairs; | |

3.2.1. Sub-Problem Construction

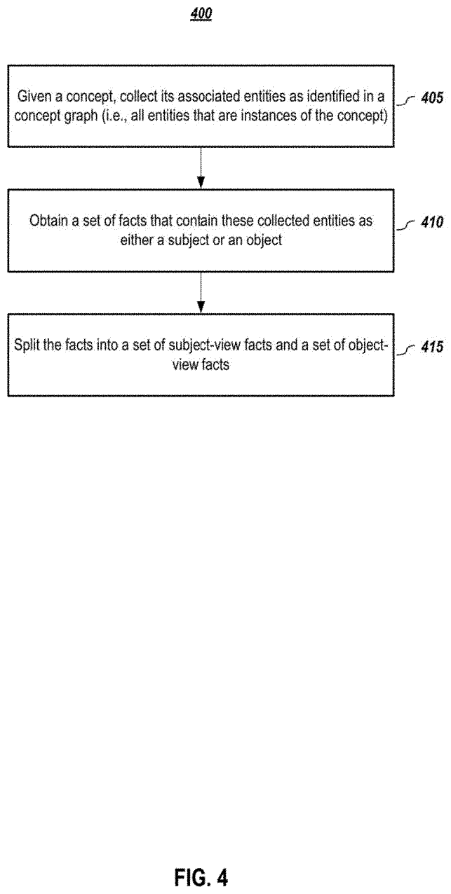

FIG. 4 depicts a method for obtaining a set of relevant facts, according to embodiments of the present disclosure. In one or more embodiments, given a concept c ∈ C, all its entities E_{c} ⊂ E are collected (405) from the concept graph. Then, a set of facts F_{c} that contain these entities are obtained (410). Since an entity can appear in a fact as a subject or an object, in one or more embodiments, the facts F_{c} are split (415) into subject-view facts F_{c,s} and object-view facts F_{c,o}. If all of the relations under the subject or object view are used, it may be inefficient to learn the sparse network structure with a large number of relation variables. Hence, based on the facts, in one or more embodiments, possible related relations to the concept c are selected to reduce the complexity of the problem.

3.2.2. Relation Selection

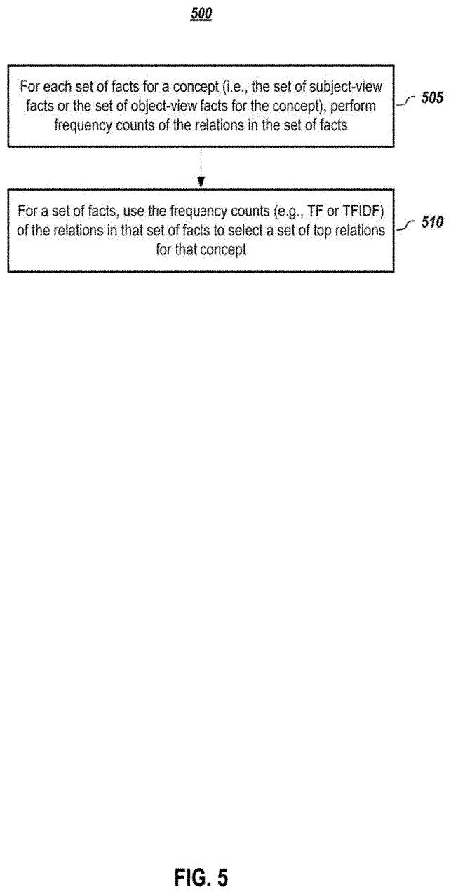

There are various strategies which can be applied for the relation selection. FIG. 5 depicts an example method for relation selection, according to embodiments of the present disclosure. It may be assumed that a relation is highly related to the concept if it appears many times in the fact set F_{c}. In this way, the frequencies of relations for each view may be counted (505), and the frequencies may be used to select (510) the top K relations as the most relevant ones for the concept. In one or more embodiments, a term-frequency (TF) selection may be used since it measures the relevance of a relation according to its frequency. In one or more alternative embodiments, the frequency counts may also be used to select relations according to a term frequency-inverse document frequency (TFIDF) method (e.g., Ho Chung Wu, Robert Wing Pong Luk, Kam-Fai Wong, and Kui-Lam Kwok, “Interpreting TFIDF term weights as making relevance decisions,” ACM Trans. Inf. Syst., 26(3):13:1-13:37 (2008)). In any event, in one or more embodiments, for each view, the most relevant K relations for the concept c are selected (510). They may be denoted as R_{c,s} ⊂ R for the subject-view facts and R_{c,o} ⊂ R for the object-view facts.

In summary, in one or more embodiments, for each concept, two sub-problems are constructed for the BNSL task. One is from the subject view, and the other is from the object view. Under each view, the sub-problem contains one concept and at most K relations. A goal is to learn a network structure from the concept and corresponding relations.

3.2.3. Data Observations

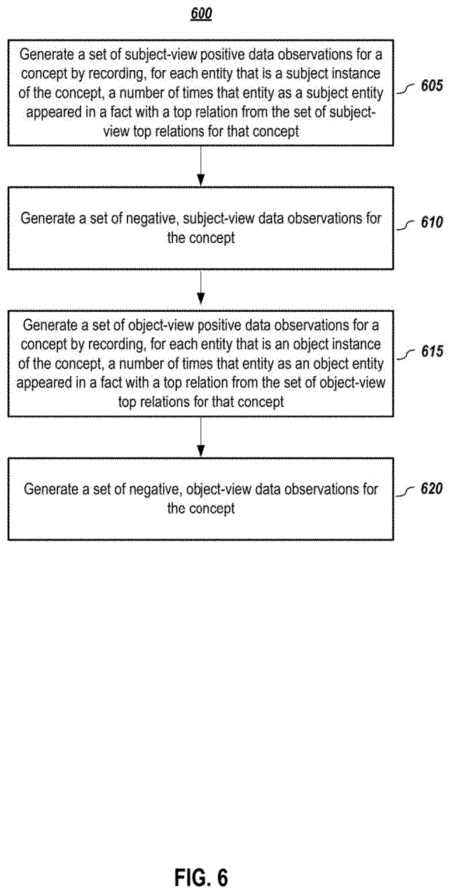

FIG. 6 depict a method for generating data observations, according to embodiments of the present disclosure. Given a sub-problem for a concept c, the corresponding data observations are obtained and then fed as the input of BNSL for interpretable relationship discoveries. In one or more embodiments, for each concept, a Bayesian network structure may be learned from its top subject-view or object view relations. The data observations X_{c,s} with TF relation selection for the subject-view of the concept c may be generated as follows: for each entity e ∈ E_{c}, a “1” may be used to denote the concept observation, meaning that the entity e is an instance of concept c. In one or more embodiments, the number of times the subject e and a top relation r ∈ R_{c,s} appear together in facts F_{c,s} is used as a relation observation for e and r. The K relation observations and the concept observation together become (605) the positive data observations for c.

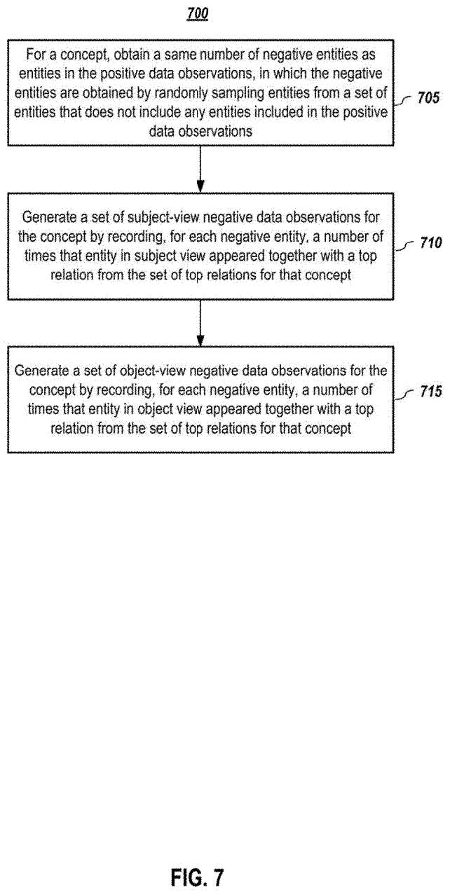

FIG. 7 depicts a method for generating negative data observations, according to embodiments of the present disclosure. In order to learn meaningful network structures, in one or more embodiments, an equal number of negative data observations for c are generated (610). In one or more embodiments, negative data observations may be generated as follows. First, the same number of entities may be randomly sampled (705) from E_{c′}={eᵢ:eᵢ ∈ E\E_{c}} as negative entities of c. “0” may be used to denote the concept observation for negative entities. For each negative entity e′, the number of times the subject e′ and a relation r ∈ R_{c,s} appear (710) in all the collected facts are counted as a relation observation for e′ and r. The K relation observations and the concept observation together become the negative data observations for c. In one or more embodiments, X_{c,s} comprises both the positive and negative data observations. Similarly, the data observations X_{c,o} for the object view may be generated (615, 620, and 715).

3.2.4. Network Structure Learning

As noted above, a number of exact and approximate algorithms may be used to learn optimal Bayesian networks. In one or more embodiments, the widely-used Chow-Liu tree building algorithm as the BNSL method. This algorithm approximates the underlying distributions of variables as a dependency tree, which is a graph where each node only has one parent and cycles are not allowed. It first calculates the mutual information between each pair of nodes (i.e., variables), and then take the maximum spanning tree of that matrix as the approximation. While this provides an approximation of the underlying data, it provides good results for many applications, especially when one wants to know the most important influencer on each variable. In addition, this algorithm is extremely efficient when it deals with a large number of variables.

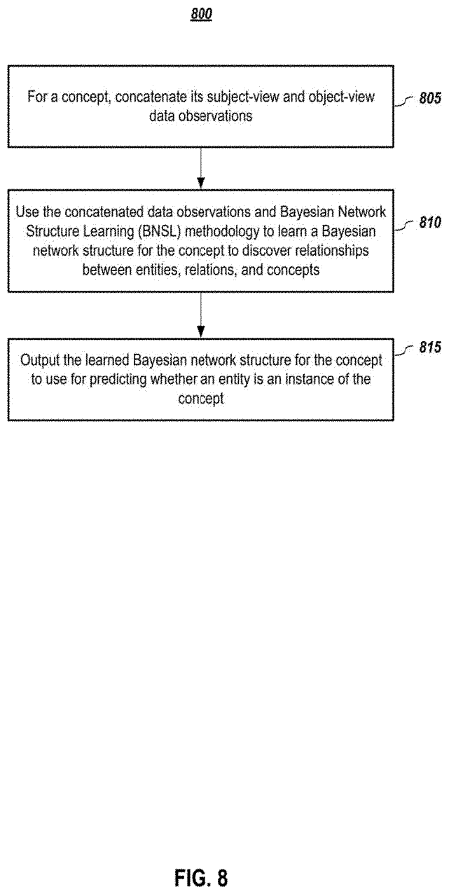

FIG. 8 depicts a method for learning a network structured, according to embodiments of the present disclosure. Since both the subject and object views reflect some properties of entities, in one or more embodiments, the subject-view relations and object-view relations are concatenated (805) together for a more complete representation of entities. The concatenated data can be forwarded (810) into BNSL for a more comprehensive result of interpretable relationship discovery. Given q concept variables and K relevant relations for each concept, the number of parameters in BNSL is at most q×K. The output is (815) a learned Bayesian network structure for the concept, which may be used for predicting whether an entity is an instance of the concept.

3.2.5. Prediction

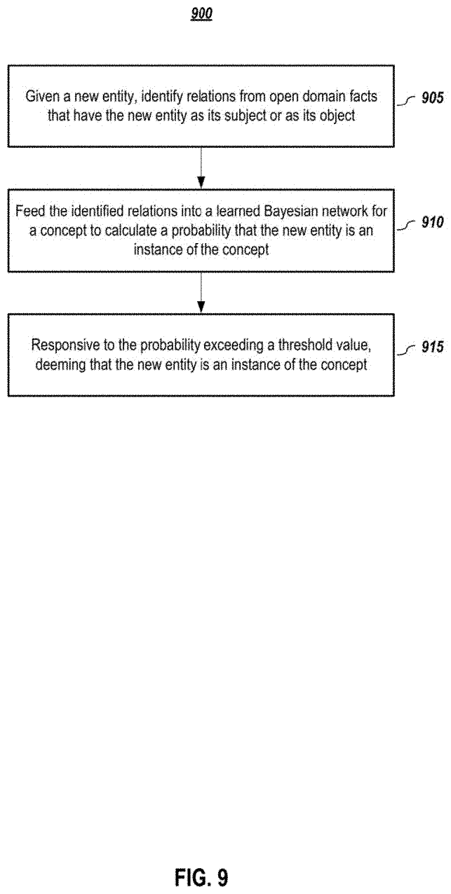

After we learn a network structure for each concept, the concept of a new entity e may be easily learned. FIG. 9 depicts a method for using a learned network for predicting whether an entity is an instance of the concept, according to embodiments of the present disclosure. In one or more embodiments, the open domain facts with e as its subject or object are identified (905), and then, the observation of relations for a concept c are feed (910) into the learned network to calculate the probability of p(c|e). In one or more embodiments, responsive to the probability exceeding a threshold value, the new entity is treating or deeming (915) an instance of the concept.

Using the open domain entity “Anderson” and its two facts introduced above as an example to show how BNSL works, assume there are two open domain concepts, “English presenter” and “Japanese presenter”. Given the entity “Anderson” and its open domain relations “host” and “winner of a British Comedy Award” as input of BNSL, the output is the probabilities that “Anderson” belongs to each concept. The BNSL network will predict a higher probability for “Anderson” having the concept “English presenter” than having “Japanese presenter.”

### 4. Experiments

It shall be noted that these experiments and results are provided by way of illustration and were performed under specific conditions using a specific embodiment or embodiments; accordingly, neither these experiments nor their results shall be used to limit the scope of the disclosure of the current patent document.

With the learned relationship between relations and concepts from BNSL, embodiments indirectly associate entities with their concepts and give interpretations to the question “why the entity is associated with those concepts in open domain”. The hypernymy detection task aims to identify concepts for entities in open domain. It is helpful to evaluate the quality of the learned relationships from BNSL. In this section, extensive experiments were conducted to evaluate the performance of BNSL.

4.1. Data Description

The performance of embodiments was tested on two datasets, one is in English and the other is in Chinese. For the English dataset, we use 15 million high-precision OIE facts, a concept graph and almost 8 million open domain sentences for experiments. Since there are more than 5 million concepts in the English dataset and most of them have few entities, those concepts with more than 50 entities were a focus in the experiments. For the Chinese dataset, we use sentences and the corresponding facts. The concept graph was also built by Baidu Baike. Table 2 shows the statistics of the concept graphs and open domain facts.

TABLE 2
Statistics of concept graphs and facts.

| | | | # | # | % |
|---|---|---|---|---|---|
| | Dataset | # entities | concepts | overlaps | overlaps |
| Concept | English | ~12,500,000 | 5,376,526 | 613,454 | 27.10% |
| Graphs | Chinese | ~9,230,000 | 3,245 | 475,507 | 48.14% |

| | Dataset | # facts | # subjects | # objects | # predicates |
|---|---|---|---|---|---|
| Facts | English | 14,728,268 | 1,396,793 | 1,698,028 | 664,746 |
| | Chinese | 37,309,458 | 624,632 | 550,404 | 10,145 |

In open domain facts, each mention of a subject or object is considered as an open domain entity. So, an entity in open domain facts and concept graphs are mapped by the same mention. In Table 2, the column “# of overlap” is about the number of fact entities appearing in the concept graph and the last column is the percentage of fact entities in the concept graph. With the predicates as relations for the open domain facts, the Bayesian network structure learning method was built to bridge the gap between relations in open domain facts and concepts in the concept graph.

4.2. Experimental Setting

In the experiment, embodiments were compared with the state-of-the-art model HypeNet (Vered Shwartz, Yoav Goldberg, and Ido Dagan, “Improving hypernymy detection with an integrated path-based and distributional method,” in Proceedings of the 54th Annual Meeting of the Association for Computational Linguistics (ACL), pages 2389-2398, Berlin, Germany (2016)) for hypernymy detection. HypeNet improves the detection of entity-concept pairs with an integrated path-based and distributional method. An entity and a concept must appear together in a sentence so that HypeNet can extract lexico-syntactic dependency paths for training and prediction. However, only less than 11% of entity-concept pairs co-occur in Dataset 1 sentences in reality (Table 1). Therefore, a BNSL embodiment was compared with HypeNet on the entity-concept pairs that co-appear in sentences.

In addition, a BNSL embodiment was compared with recurrent neural networks (RNNs). An attention-based Bi-LSTM (Peng Zhou, Wei Shi, Jun Tian, Zhenyu Qi, Bingchen Li, Hongwei Hao, and Bo Xu, “Attention-based bidirectional long short-term memory networks for relation classification,” in Proceedings of the 54^{th} Annual Meeting of the Association for Computational Linguistics (ACL), Berlin, Germany (2016)) was applied and three versions of RNNs were derived as baseline methods, RNN(f), RNN(sen) and RNN(e). RNN(f) determines the concepts of an entity according to the facts containing the entity, while RNN(sen) by the sentences containing the co-appearance of an entity and a concept. Specifically, each entity in RNN(f) is represented by its associated facts. Each fact is a sequence of subject, predict, and object. Each subject, predict, and object vector is fed in sequence into RNN(f), resulting a fact embedding vector. The averaged fact vector becomes the entity's feature for concept classification.

Similar to HypeNet, RNN(sen) requires the entity-concept pairs co-appearing in sentences. Different from RNN(sen), RNN(e) focuses on sentences containing the entity only. Based on the sentences, RNN(e) aims to learn which concept an entity belongs to. HypeNet and RNN were followed to use pre-trained GloVe embeddings (Jeffrey Pennington, Richard Socher, and Christopher D. Manning, “Glove: Global vectors for word representation,” in Proceedings of the 2014 Conference on Empirical Methods in Natural Language Processing (EMNLP), pages 1532-1543, Doha, Qatar (2014)) for initialization. Besides, the tested BNSL embodiment was compared with traditional support vector machines (SVM) with linear kernel. The input features for SVM and the tested BNSL embodiment were the same, i.e., the top K relations for each concept, with K=5. During testing, all methods were evaluated on the same testing entities. The accuracy, precision, recall, and F1-score were calculated over the prediction results for evaluation. The data was split into 80% training and 20% testing. For English, the total numbers of training and testing data were 504,731 and 123,880, respectively; whereas for Chinese, the numbers were 5,169,220 and 1,289,382, respectively.

4.3. Performance Evaluation

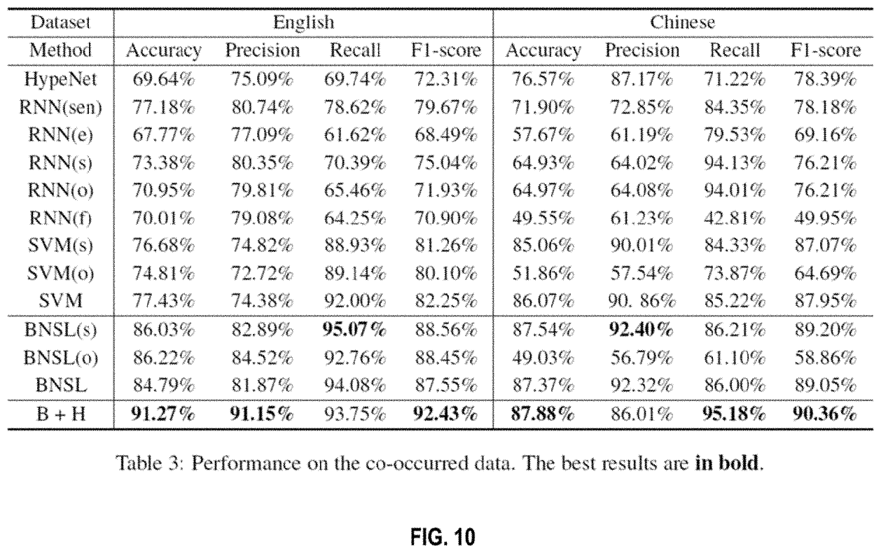

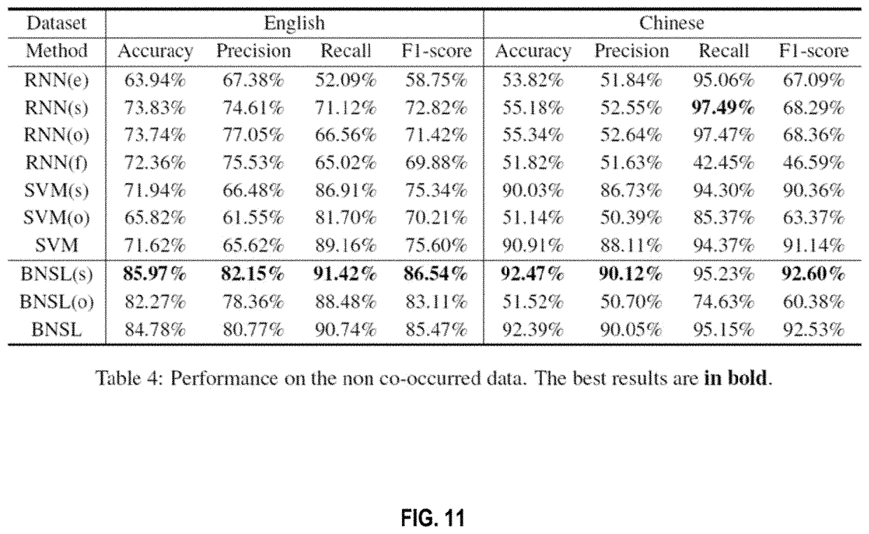

In this section, the evaluation performance on the task of concept discovery with the learned interpretable relationships from open domain fact are shown. Table 3 (see FIG. 10) and Table 4 (see FIG. 11) list the results for co-occurred and non-co-occurred entity-concept pairs in sentences, respectively. In the tables, (s) and (o) mean the performance only under the subject and the object view, respectively. RNN(f), BNSL, and SVM present the prediction performance with the concatenation of both the subject and object views. As is mentioned in the previous section, TF or TFIDF may be used for the most relevant relation selection. Both strategies for BNSL and SVM were tested. For the English dataset, TFIDF performed much better than TF while the result is the opposite for the Chinese dataset. In this section, the results of the tested BNSL embodiment and SVM were analyzed with TFIDF for the English dataset. For the Chinese dataset, the performance of the tested BNSL embodiment and SVM with TF are reported. More results for the relation selection are shown in the next section.

For the co-occurred entity-concept pairs in sentences, the tested BNSL(s) embodiment performed the best for both datasets. Surprisingly, SVM performs much better than HypeNet with an improvement of around 10% on accuracy for both datasets as is shown in Table 3. In addition, SVM achieves better results compared to RNN(sen). The reason that HypeNet or RNN(sen) cannot perform well may be that the information expressed from the sentences are too diverse. HypeNet or RNN(sen) cannot capture meaningful patterns from sentences for the task of concept discovery. Since RNN(e) further ignores the concept information during the sentence collection step, it cannot perform well compared with RNN(sen). In contrast, information extracted from open domain facts are much more concentrated about concepts. Furthermore, the most relevant relations associated with entities help filtering out noise. Therefore, SVM can achieve a much better result than sentence-based baselines. Although SVM does well on the co-occurred data, the BNSL embodiment outperforms SVM with all the four evaluation metrics. By learning interpretable relationships between relations and concepts, the BNSL embodiment captures the most important knowledge about concepts and further exploits their dependencies to help improve the concept discovery task. However, the concatenation of subject and object views for the BNSL embodiment did help improve the performance for both datasets. Similar phenomena can be observed for RNN(f) and SVM. Specifically, the results under the subject view are usually better than those of the object view, implying that when people narrate facts, they may pay more attention to selecting suitable predicate for subjects, rather for objects. Table 4 lists the performances of RNN(e), RNN(f), SVM, and BNSL on non-co-occurred data. A similar trend can be observed in comparison to the results on co-occurred data. Since HypeNet and the BNSL embodiment make use of different information sources (natural language sentences for HypeNet and open domain facts for the BNSL embodiment), an ensemble of them was tried to improve the performance further. HypeNet and the BNSL embodiment were trained independently. Then, prediction probabilities of entity-concept pairs were obtained from HypeNet and the BNSL embodiment separately. The probabilities with higher values was selected as the final predictions. The last row in Table 3 shows the performance of ensembling HypeNet and the BNSL embodiment. It is denoted as B+H. It can be seen that B+H achieves the best accuracy, recall, and F1-scores on the co-occurred data. It reveals that interpretable relationships extracted from open domain facts are complementary to natural language sentences in helping concept discovery. Studying meaningful knowledge from open domain facts provides an alternative perspective to build concept graphs.

4.4. Analysis on the Relation Selection

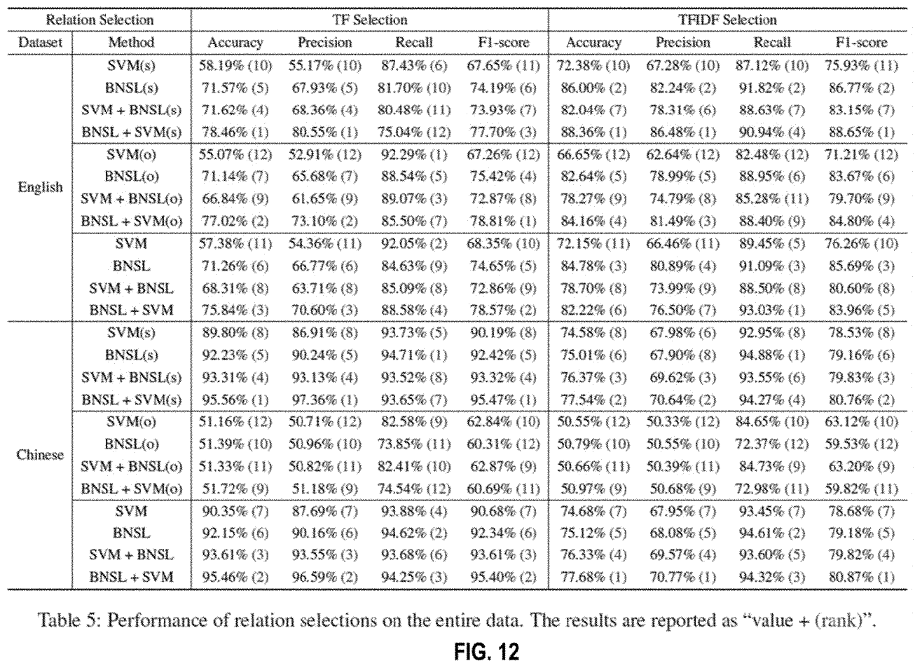

Relation selection helps reduce the complexity of the BNSL embodiment. In this section, how different relation selection strategies influence the performance of BNSL and SVM methods are evaluated. Table 5 (FIG. 12) is the performance of TF and TFIDF relation selection on the entire data for both English and Chinese. It was observed that TFIDF selection performs better on English, while TF is better on Chinese. However, the BNSL embodiment always outperforms SVM regardless of the views or the relation selections. In addition, since SVM performs much better than the neural-network-based HypeNet and RNN, an ensemble was tried with the BNSL embodiment to improve the performance further. The prediction probabilities of SVM were considered as a new variable and it was incorporated into a BNSL embodiment for network structure learning. The model is denoted as BNSL+SVM. For comparison, SVM was ensembled with the BNSL embodiment by taking the results of the BNSL embodiment as one new feature dimension to SVM. It was named SVM+BNSL. It can be seen from Table 5 (FIG. 12) that the ensemble of a BNSL embodiment and SVM outperforms single models on both datasets. Especially, BNSL+SVM does better than SVM+BNSL, revealing that BNSL has a better capability of exploring meaningful knowledge from other sources.

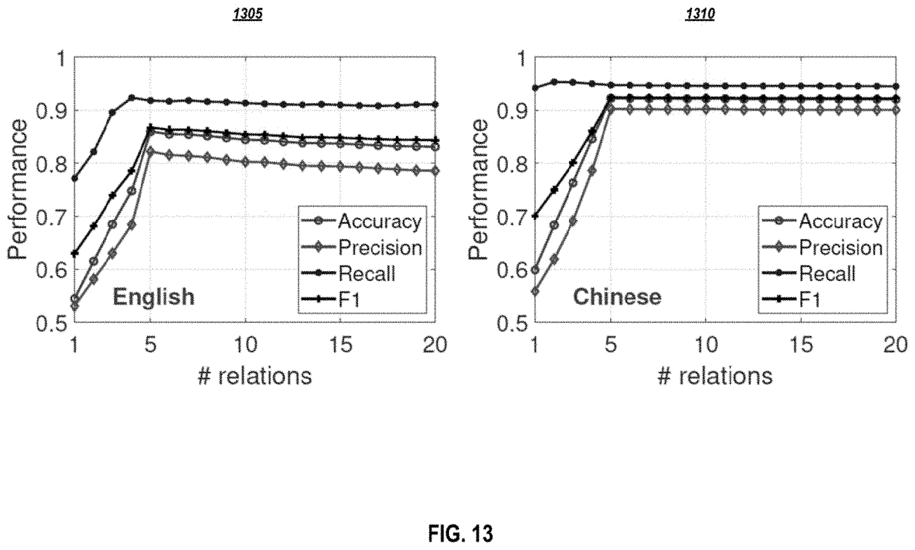

Furthermore, how a BNSL embodiment performs with different numbers of relations was evaluated. FIG. 13 shows the results of the BNSL(s) embodiment by setting relation numbers from 1 to 20. TFIDF relation selection was used for the English dataset and TF for the Chinese dataset. It can be observed that the BNSL embodiment performs best when the top 5 relations are selected, and the results become stable with more than 5 relations.

4.5. Analysis with Missing Information

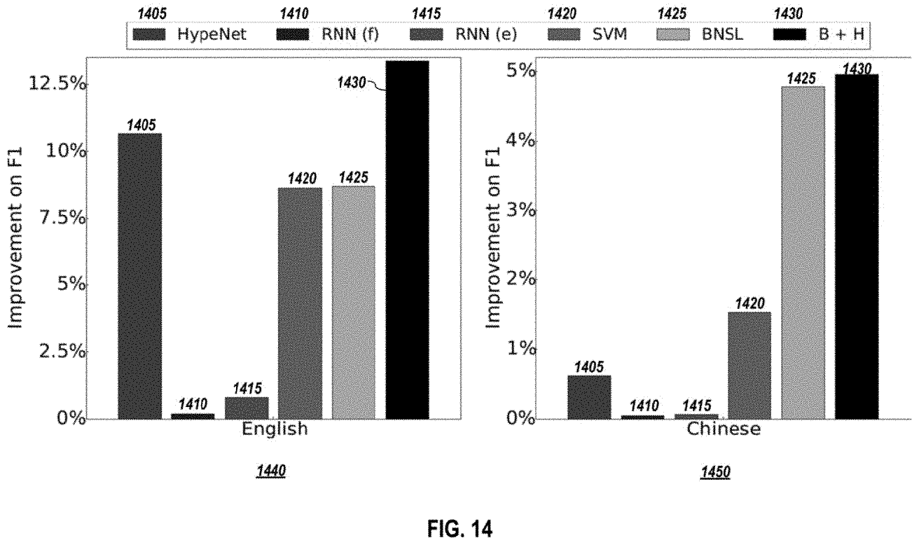

In reality, the open domain facts or co-occurring sentences associated with entity-concept pairs are usually missing, making the input information for concept discovery extremely sparse. In this section, it is studied how BNSL performs with the sparse input. Given a set of entities, the corresponding facts (or sentences) under each concept are extracted. For both datasets, around 30 million entity-concept pairs are obtained for testing and more than 97% do not have the corresponding fact information with the top K relations, making the prediction of BNSL very challenging. Furthermore, both datasets have a large number of fine-grained concepts, making the task more difficult. For the missing data, an empty fact or sentence was input into the tested BNSL embodiment and other models for training and testing. Also, it was observed that RNN does not perform as well compared with other methods and in particular RNN(sen) performs the worst when the input is extremely sparse. In FIG. 14, the improvement of F1-score over RNN(sen) is reported. It can be observed that HypeNet, SVM, and the BNSL embodiment achieve much better performance, showing their robustness with missing values. In addition, B+H can still achieve the best result. It further confirms that open domain facts and natural language sentences are complementary to each other even when there is a large portion of missing information.

### 5. Some Conclusions

In this patent document, the task of learning interpretable relationships between entities, relations, and concepts from open domain facts to help enriching and refining concept graphs was undertaken. In one or more embodiments, the Bayesian network structures are learned from open domain facts as the discovered meaningful dependencies between relations of facts and concepts of entities. Experimental results on an English dataset and a Chinese dataset reveal that the learned network structures can better identify concepts for entities based on the relations of entities from open domain facts, which will further help building a more complete concept graph.

### 6. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more disk drives, one or more network ports for communicating with external devices as well as various input and output (I/O) devices, such as a keyboard, mouse, stylus, touchscreen and/or video display. The computing system may also include one or more buses operable to transmit communications between the various hardware components.

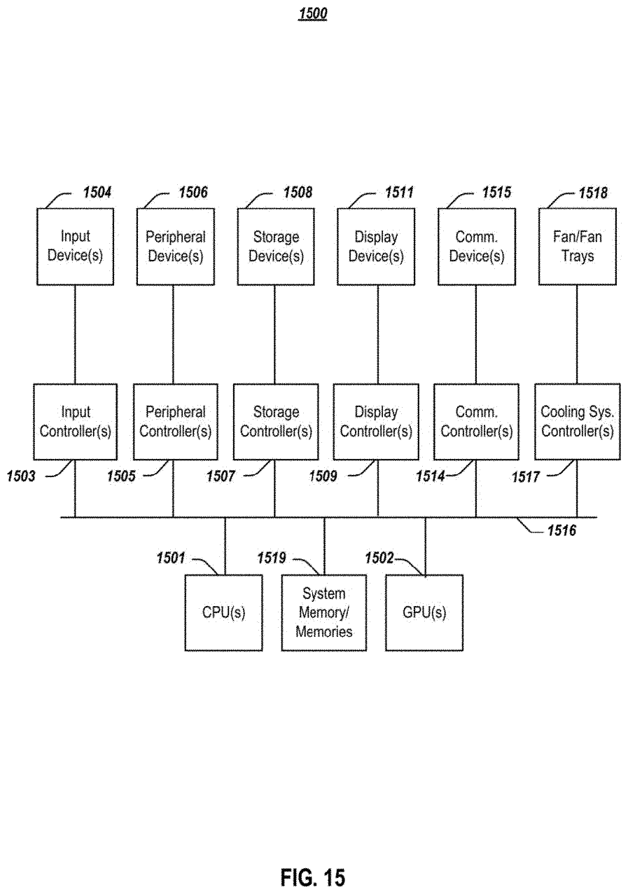

FIG. 15 depicts a simplified block diagram of an information handling system (or computing system), according to embodiments of the present disclosure. It will be understood that the functionalities shown for system 1500 may operate to support various embodiments of a computing system—although it shall be understood that a computing system may be differently configured and include different components, including having fewer or more components as depicted in FIG. 15.

As illustrated in FIG. 15, the computing system 1500 includes one or more central processing units (CPU) 1501 that provides computing resources and controls the computer. CPU 1501 may be implemented with a microprocessor or the like, and may also include one or more graphics processing units (GPU) 1502 and/or a floating-point coprocessor for mathematical computations. In one or more embodiments, one or more GPUs 1502 may be incorporated within the display controller 1509, such as part of a graphics card or cards. Thy system 1500 may also include a system memory 1519, which may comprise RAM, ROM, or both.

A number of controllers and peripheral devices may also be provided, as shown in FIG. 15. An input controller 1503 represents an interface to various input device(s) 1504, such as a keyboard, mouse, touchscreen, and/or stylus. The computing system 1500 may also include a storage controller 1507 for interfacing with one or more storage devices 1508 each of which includes a storage medium such as magnetic tape or disk, or an optical medium that might be used to record programs of instructions for operating systems, utilities, and applications, which may include embodiments of programs that implement various aspects of the present disclosure. Storage device(s) 1508 may also be used to store processed data or data to be processed in accordance with the disclosure. The system 1500 may also include a display controller 1509 for providing an interface to a display device 1511, which may be a cathode ray tube (CRT) display, a thin film transistor (TFT) display, organic light-emitting diode, electroluminescent panel, plasma panel, or any other type of display. The computing system 1500 may also include one or more peripheral controllers or interfaces 1505 for one or more peripherals 1506. Examples of peripherals may include one or more printers, scanners, input devices, output devices, sensors, and the like. A communications controller 1514 may interface with one or more communication devices 1515, which enables the system 1500 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1500 comprises one or more fans or fan trays 1518 and a cooling subsystem controller or controllers 1517 that monitors thermal temperature(s) of the system 1500 (or components thereof) and operates the fans/fan trays 1518 to help regulate the temperature.

In the illustrated system, all major system components may connect to a bus 1516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, for example: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method comprising:
obtaining a set of entities that are identified in a concept graph as being associated with a concept;
searching an information repository comprising facts from open domain information to obtain a set of facts that contain an entity from the set of entities as either a subject or an object of a fact, in which each fact comprises a subject entity, an object entity, and a relation that represents a predicate or relationship between the subject entity and the object entity;
using at least some of the set of facts to generate positive data observations for the concept that relate at least some of the entities in the set of entities to one or more relations from the set of facts;
using a Bayesian network structure learning methodology and at least some of the positive data observations to learn a Bayesian network for the concept to discover a network structure between entities, relations, and the concept; and
outputting the learned Bayesian network for the concept to use for predicting whether a new entity is an instance of the concept.

2. The computer-implemented method of claim 1 further comprising:
repeating the steps of claim 1 for each concept of a plurality of concepts to obtain a learned Bayesian network for each concept.

3. The computer-implemented method of claim 1 further comprising:
inputting a new entity and one or more relations from one or more facts that include the new entity as a subject entity or as an object entity into the learned Bayesian network for the concept to predict whether the new entity is an instance of the concept.

4. The computer-implemented method of claim 3 further comprising:
given one or more new entities that have been predicted as instances of the concept, updating the concept graph with the one or more new entities; and
repeating the steps of claim 1 to obtain an updated learned Bayesian network for the concept.

5. The computer-implemented method of claim 1 further comprising:
generating negative data observations in which an entity in a negative data observation is an entity that is not an instance of the concept and was not included in the set of entities; and
wherein the step of using a Bayesian network structure learning methodology and at least the positive data observations to learn a Bayesian network for the concept to discover a network structure between entities, relations, and the concept, comprises:
using the Bayesian network structure learning methodology and the positive data observations and the negative data observations to learn the Bayesian network for the concept.

6. The computer-implemented method of claim 1 wherein the step of using at least some of the set of facts to generate positive data observations that relate at least some of the entities in the set of entities to one or more relations from the set of facts, comprises:
generating a set of subject-view positive data observations for the concept by recording, for each entity that is a subject instance of the concept, a number of times that entity as a subject entity appeared in a fact with a top relation from a set of subject-view top relations for the concept; and
generating a set of object-view positive data observations for a concept by recording, for each entity that is an object instance of the concept, a number of times that entity in object view appeared in a fact with a top relation from a set of object-view top relations for the concept.

7. The computer-implemented method of claim 6 wherein the set of subject-view top relations and the set of object-view top relations are obtained by performing the steps comprising:
splitting the set of facts into a set of subject-view facts and a set of object-view facts, wherein the set of subject-view facts comprise facts from the set of facts in which an entity from the set of entities is the subject entity and wherein the set of object-view facts comprise facts from the set of facts in which an entity from the set of entities is the object entity;
for the set of subject-view facts, using frequency of occurrence of relations in the set of subject-view facts to select the set of subject-view top relations; and
for the set of object-view facts, using frequency of occurrence of relations in the set of object-view facts to select the set of object-view top relations.

8. A non-transitory computer-readable medium or media comprising one or more sequences of instructions which, when executed by at least one processor, causes steps to be performed comprising:
obtaining a set of entities that are identified in a concept graph as being associated with a concept;
searching an information repository comprising open domain facts to obtain a set of facts that contain an entity from the set of entities as either a subject or an object of a fact, in which each fact comprises a subject entity, an object entity, and a relation that represents a predicate or relationship between the subject entity and the object entity;
using at least some of the set of facts to generate positive data observations for the concept that relate at least some of the entities in the set of entities to one or more relations from the set of facts;
using a Bayesian network structure learning methodology and at least some of the positive data observations to learn a Bayesian network for the concept to discover a network structure between entities, relations, and the concept; and
outputting the learned Bayesian network for the concept to use for predicting whether a new entity is an instance of the concept.

9. The non-transitory computer-readable medium or media of claim 8 wherein the non-transitory computer-readable medium or media further comprises one or more sequences of instructions which, when executed by at least one processor, causes steps to be performed comprising
repeating the steps of claim 8 for each concept of a plurality of concepts to obtain a learned Bayesian network.

10. The non-transitory computer-readable medium or media of claim 8 wherein the non-transitory computer-readable medium or media further comprises one or more sequences of instructions which, when executed by at least one processor, causes steps to be performed comprising:
inputting a new entity and one or more relations from one or more facts that include the new entity as a subject entity or as an object entity into the learned Bayesian network for the concept to predict whether the new entity is an instance of the concept.

11. The non-transitory computer-readable medium or media of claim 10 wherein the non-transitory computer-readable medium or media further comprises one or more sequences of instructions which, when executed by at least one processor, causes steps to be performed comprising:
given one or more new entities that have been predicted as instances of the concept, updating the concept graph with the one or more new entities; and
repeating the steps of claim 1 to obtain an updated learned Bayesian network for the concept.

12. The non-transitory computer-readable medium or media of claim 8 wherein the non-transitory computer-readable medium or media further comprises one or more sequences of instructions which, when executed by at least one processor, causes steps to be performed comprising:
generating negative data observations in which an entity in a negative data observation is an entity that is not an instance of the concept and was not included in the set of entities; and
wherein the step of using a Bayesian network structure learning methodology and at least the positive data observations to learn a Bayesian network for the concept to discover a network structure between entities, relations, and the concept, comprises:
using the Bayesian network structure learning methodology and the positive data observations and the negative data observations to learn the Bayesian network for the concept.

13. The non-transitory computer-readable medium or media of claim 8 wherein the step of using at least some of the set of facts to generate positive data observations that relate at least some of the entities in the set of entities to one or more relations from the set of facts, comprises:
generating a set of subject-view positive data observations for the concept by recording, for each entity that is a subject instance of the concept, a number of times that entity as a subject entity appeared in a fact with a top relation from a set of subject-view top relations for the concept; and
generating a set of object-view positive data observations for a concept by recording, for each entity that is an object instance of the concept, a number of times that entity in object view appeared in a fact with a top relation from a set of object-view top relations for the concept.

14. The non-transitory computer-readable medium or media of claim 13 wherein the set of subject-view top relations and the set of object-view top relations are obtained by performing the steps comprising:
splitting the set of facts into a set of subject-view facts and a set of object-view facts, wherein the set of subject-view facts comprise facts from the set of facts in which an entity from the set of entities is the subject entity and wherein the set of object-view facts comprise facts from the set of facts in which an entity from the set of entities is the object entity;
for the set of subject-view facts, using frequency of occurrence of relations in the set of subject-view facts to select the set of subject-view top relations; and
for the set of object-view facts, using frequency of occurrence of relations in the set of object-view facts to select the set of object-view top relations.

15. A system comprising:
one or more processors; and
a non-transitory computer-readable medium or media comprising one or more sets of instructions which, when executed by at least one of the one or more processors, causes steps to be performed comprising:
obtaining a set of entities that are identified in a concept graph as being associated with a concept;
searching an information repository comprising open domain facts to obtain a set of facts that contain an entity from the set of entities as either a subject or an object of a fact, in which each fact comprises a subject entity, an object entity, and a relation that represents a predicate or relationship between the subject entity and the object entity;
using at least some of the set of facts to generate positive data observations for the concept that relate at least some of the entities in the set of entities to one or more relations from the set of facts;
using a Bayesian network structure learning methodology and at least some of the positive data observations to learn a Bayesian network for the concept to discover a network structure between entities, relations, and the concept; and
outputting the learned Bayesian network for the concept to use for predicting whether a new entity is an instance of the concept.

16. The system of claim 15 wherein the non-transitory computer-readable medium or media of further comprises one or more sequences of instructions which, when executed by at least one processor, causes steps to be performed comprising:
repeating the steps of claim 15 for each concept of a plurality of concepts to obtain a learned Bayesian network.

17. The system of claim 15 wherein the non-transitory computer-readable medium or media of further comprises one or more sequences of instructions which, when executed by at least one processor, causes steps to be performed comprising:
inputting a new entity and one or more relations from one or more facts that include the new entity as a subject entity or as an object entity into the learned Bayesian network for the concept to predict whether the new entity is an instance of the concept.

18. The system of claim 17 wherein the non-transitory computer-readable medium or media of further comprises one or more sequences of instructions which, when executed by at least one processor, causes steps to be performed comprising:
given one or more new entities that have been predicted as instances of the concept, updating the concept graph with the one or more new entities; and
repeating the steps of claim 1 to obtain an updated learned Bayesian network for the concept.

19. The system of claim 15 wherein the non-transitory computer-readable medium or media of further comprises one or more sequences of instructions which, when executed by at least one processor, causes steps to be performed comprising:
generating negative data observations in which an entity in a negative data observation is an entity that is not an instance of the concept and was not included in the set of entities; and
wherein the step of using a Bayesian network structure learning methodology and at least the positive data observations to learn a Bayesian network for the concept to discover a network structure between entities, relations, and the concept, comprises:
using the Bayesian network structure learning methodology and the positive data observations and the negative data observations to learn the Bayesian network for the concept.

20. The system of claim 15 wherein the step of using at least some of the set of facts to generate positive data observations that relate at least some of the entities in the set of entities to one or more relations from the set of facts, comprises:
generating a set of subject-view positive data observations for the concept by recording, for each entity that is a subject instance of the concept, a number of times that entity as a subject entity appeared in a fact with a top relation from a set of subject-view top relations for the concept; and
generating a set of object-view positive data observations for a concept by recording, for each entity that is an object instance of the concept, a number of times that entity in object view appeared in a fact with a top relation from a set of object-view top relations for the concept.

21. The system of claim 15 wherein the set of subject-view top relations and the set of object-view top relations are obtained by performing the steps comprising:
splitting the set of facts into a set of subject-view facts and a set of object-view facts, wherein the set of subject-view facts comprise facts from the set of facts in which an entity from the set of entities is the subject entity and wherein the set of object-view facts comprise facts from the set of facts in which an entity from the set of entities is the object entity;
for the set of subject-view facts, using frequency of occurrence of relations in the set of subject-view facts to select the set of subject-view top relations; and
for the set of object-view facts, using frequency of occurrence of relations in the set of object-view facts to select the set of object-view top relations.
